(19) United States
(12) Patent Application Publication
(10) Pub. No.: US 2023/0378554 A1
(43) Pub. Date: Nov. 23, 2023

(54) METHOD FOR DISCHARGING AN ELECTROCHEMICAL GENERATOR

(71) Applicants: COMMISSARIAT À L'ÉNERGIE ATOMIQUE ET AUX ÉNERGIES ALTERNATIVES, Paris (FR); ORANO, Chatillon (FR)

(72) Inventors: Emmanuel Billy, Grenoble (FR); David Brunbuisson, Grenoble (FR); Mathilde Guilpain, Grenoble (FR)

(21) Appl. No.: 18/248,261

(22) PCT Filed: Oct. 5, 2021
(86) PCT No.: PCT/FR2021/051724

§ 371 Date: Apr. 7, 2023

(30) Foreign Application Priority Data
Oct. 9, 2020 (FR) 2010324

(51) Int. Cl. H01M 10/44; H01M 4/38; H01M 10/54

(52) U.S. Cl. CPC H01M 10/44; H01M 4/382; H01M 10/54; H01M 2004/028

(57) ABSTRACT

A method for discharging an electrochemical generator comprising a negative electrode containing lithium or sodium and a positive electrode, the method comprising a step of discharging the electrochemical generator during which the electrochemical generator is brought into contact with an ionic liquid solution comprising a solvent ionic liquid and an electrically-conductive powder so as to discharge it.

### TECHNICAL FIELD

The present invention relates to a method for discharging an electrochemical generator, such as a Li-Ion, Na-Ion, or Lithium-metal accumulator or battery, in particular for recycling thereof and/or for storage thereof.

The electrochemical generator can be safely discharged and the recoverable fractions can be recycled.

The invention is particularly interesting for recycling of electrochemical systems such as modules, batteries, accumulators or cells treated separately or in a mixture.

### PRIOR ART

An electrochemical generator is an electric power production device converting chemical energy into electrical energy. For example, it may consist of cells or accumulators.

The market for accumulators, and in particular lithium accumulators, of the Li-ion type, is currently expanding rapidly, on the one hand, because of so-called nomadic applications (smartphone, computer, camera, . . . ) and, on the other hand, because of new applications related to mobility (electric and hybrid vehicles) and so-called stationary applications (connected to the power grid).

Because of the growing number of accumulators in recent years, the question of recycling thereof has therefore become a major issue.

Conventionally, a lithium-ion accumulator comprises an anode, a cathode, a separator, an electrolyte and a case.

In general, the anode is formed from graphite mixed with a PVDF-type binder deposited over a copper sheet and the cathode is a metal lithium insertion material (for example, LiCoO₂, LiMnO₂, LiNiO₂, Li₃NiMnCoO₆, or LiFePO₄) mixed with a binder and deposited over an aluminium sheet.

The electrolyte is a mixture of non-aqueous solvents and lithium salts, and possibly additives to slow down secondary reactions.

The operation is as follows: during charging, the lithium deintercalates from the metal oxide and intercalates into the graphite, where it is thermodynamically unstable. During discharge, the process is reversed and the lithium ions are intercalated in the lithium metal oxide.

As it is used, ageing leads to a loss of capacity and the cell must be recycled.

However, a large number of accumulators or accumulator batteries to be recycled are still at least partially charged and grinding thereof produces sparks and significant ignitions and even explosions, in particular with primary lithium batteries (Li—SOCl₂).

Damaged cells must also be recycled. However, these cells may have metallic lithium deposits on the anode, which are very reactive when exposed to air or water.

Hence, end-of-life and/or damaged cells to be recycled must be handled with the utmost caution.

Conventionally, the accumulator recycling method comprises several steps:
a pre-processing step including a dismantling phase and a securing phase,
thermal and/or hydrometallurgical treatments to recover the different recoverable materials and metals contained in these cells and accumulators.

To date, the main problem lies in the phase of safeguarding these (primary and secondary) lithium-based electrochemical systems.

Indeed, upon loss of containment, electrolyte, a toxic, flammable and corrosive product, in liquid form but also gaseous leaks occur. The vapours thus generated and mixed with air can then form an explosive atmosphere (ATEX). The latter could ignite on contact with a spark-type ignition source or a hot surface. This then results in an explosion causing thermal effects and pressure effects. In addition, electrolyte salts such as lithium hexafluorophosphate LiPF₆, lithium tetrafluoborate LiBF₄, lithium perchlorate LiClO₄, lithium hexafluoroarsenate LiAsF₆ could release particularly toxic and corrosive fumes containing phosphorus, fluorine and/or lithium. For example, there might be the formation of hydrofluoric acid (HF) during the thermal degradation of Li-ion batteries.

To overcome these drawbacks, it is possible to grind the batteries in a chamber with a controlled atmosphere and pressure. As example, the document WO 2005/101564 A1 describes a method for recycling a lithium anode battery by hydrometallurgical means, at room temperature and under an inert atmosphere. The atmosphere comprises argon and/or carbon dioxide. The two gases will expel the oxygen and form a protective headspace above the crushed load. The presence of carbon dioxide will lead to the initiation of passivation of metallic lithium by formation of lithium carbonate at the surface, which slows down the reactivity of this metal. The hydrolysis of the ground load containing lithium leads to the formation of hydrogen. To avoid the risks of ignition of the hydrogen and of explosion, the ground load containing lithium is added in a very controlled manner in the aqueous solution and a very strong turbulence above the bath is created. This operation is associated with a depletion of the atmosphere in oxygen. The water becomes rich in lithium hydroxide and lithium is recovered by addition of sodium carbonate or phosphoric acid.

In the method of the U.S. Pat. No. 5,888,463, securing the batteries and accumulators is carried out by a cryogenic process. The cells and accumulators are frozen in liquid nitrogen at −196° C. before being crushed. Afterwards, the ground matter is immersed in water. To avoid the formation of H₂S, the pH is maintained at a pH of at least 10 by addition of LiOH. The formed lithium salts (Li₂SO₄, LiCl) are precipitated in the form of carbonate by addition of sodium carbonate.

The document CA 2 313 173 A1 describes a method for recycling lithium ion cells. The cells are cut beforehand in a water-free inert atmosphere. A first organic solvent (acetonitrile) allows dissolving the electrolyte and a second organic solvent (NMP) allows dissolving the binder. Afterwards, the particulate insert material is separated from the solution and reduced by electrolysis.

In the document WO 2011/113860 A1, a so-called dry method (“Dry-Technology”) is described. The temperature of the grinder is maintained between 40 and 50° C. and the mixture of hydrogen and oxygen, released from the batteries, is eliminated, by a cyclonic air movement, to minimise the risk of fire outbreak. The pieces of battery and dust, recovered after sieving, are cooled down to room temperature. The extraction of lithium seems to be done by reaction with oxygen and humidity in the air, causing risks related to the simultaneous presence of hydrogen, oxygen and heat conducive to combustion and explosion. Moreover, grinding of these accumulators causes crushing and short circuits which can lead to an explosion. In addition, the electrolyte is degraded, generating risks, losses and difficulties with regards to the management of dust and gases.

The UmiCore VAL'EAS™ process, described in the article by Georgi-Maschler et al. (“Development of a recycling process for Li-ion batteries” Journal of Power Sources 207 (2012) 173-182) combines pyrometallurgical and hydrometallurgical treatments. The dismantled batteries are directly introduced into a furnace. The pyrometallurgical treatment allows deactivating them: the electrolyte evaporates at almost 300° C.; the plastics are pyrolised at 700° C. and the remainder is finally melted and reduced at 1,200-1,450° C. A portion of the organic matters contained in the cells serves as a reductant agent in the process. Aluminium and lithium are lost. Iron, copper, and manganese are recovered in an aqueous solution. Cobalt and nickel are recovered as LiCoO₂ and Ni(OH)₂ and recycled to form cathode materials. However, this type of heat treatment generates high energy consumption and leads to a considerable degradation of the components of the battery.

The document EP 0 613 198 A1 describes a method for recovering materials derived from lithium cells. The cells are cut either under a high-pressure water jet or under an inert atmosphere to avoid an outbreak of fire. Then, the lithium reacts with water, an alcohol or an acid to form, respectively, lithium hydroxide, a lithium alkoxide or a lithium salt (LiCl, for example). However, the securing procedure carried out with high-pressure water jet cutting requires high water consumption and generates H₂ gases in air.

To date, the different above-described methods for safeguarding/opening cells/batteries require carrying out treatments at high temperature, cryogenic treatments, and/or under a controlled atmosphere, which are conditions difficult to implement on an industrial scale and/or expensive.

### DISCLOSURE OF THE INVENTION

The present invention aims to provide a method allowing overcoming the drawbacks of the prior art, and in particular a method allowing safeguarding an electrochemical generator, the method having to be easy to implement on an industrial scale.

This aim is achieved by a method for discharging an electrochemical generator comprising a negative electrode containing lithium or sodium and a positive electrode possibly containing lithium or sodium, the method comprising a step of discharging the electrochemical generator during which the electrochemical generator is brought into contact with an ionic liquid solution comprising a solvent ionic liquid and an electrically-conductive powder so as to discharge it.

The invention fundamentally differs from the prior art by the implementation of the step of discharging the electrochemical generator, in the presence of an ionic liquid solution comprising an electrically-conductive powder. The ionic liquids are non-volatile, non-flammable and chemical stable at temperature that could be higher than 200° C. (for example between 200° C. and 400° C.). The addition of an electrically-conductive powder leads to a resistive discharge of the electrochemical generator without any chemical action and thus to safeguarding thereof.

The method is very simple to implement since all it needs is to just bring the electrochemical generator in contact with the ionic liquid solution containing the electrically-conductive powder. Preferably, the electrochemical generator is immersed in the ionic liquid solution.

The ionic liquid solution forms a “slurry” or “mud” whose electrical and calorific properties enable a controlled and safe resistive discharge of the electrochemical generator. There is no need to implement a chemical reaction to discharge the electrochemical generator. The resistivity of the powder in the ionic liquid medium controls the electrical discharge rate. The calorific properties control the heat dissipation associated to the resistive process. The atmospheric isolation of the electrochemical generator by the ionic liquid prevents access to oxygen, water and/or air and thus avoids the generation of hydrogen. In the event of a confinement break-up (opening of the electrochemical generator), the ionic liquid ensures the discharge without any explosion and flammability risk.

By electrochemical generator, it should be understood accumulators and/or cells and/or batteries and/or modules (combinations of several accumulators).

During the discharge process, the solvent ionic liquid promotes cooling of the medium and allows discharging calories.

Optionally, the ionic liquid solution may be stirred and/or cooled. It is also possible to add to the ionic liquid solution species with advantageous calorific capacities promoting cooling.

Advantageously, the ionic liquid solution further comprises a so-called oxidant redox species able to be reduced on the negative electrode so as to discharge the electrochemical generator. This species leads to the extraction of lithium or sodium from the negative electrode (anode). The chemical species improves discharge by an oxidation-reduction reaction with lithium (or sodium).

By able to be reduced on the negative electrode, it should be understood that the active species can react either directly on the negative electrode (anode), in the case where the case of the accumulator is open, or on another element electrically connected to the anode, such as the anode current collector, the terminal of the anode or the ground when the anode is electrically connected to the ground.

Next, when lithium is described, lithium may be replaced by sodium.

For example, in the case of a lithium-metal accumulator, the reduction reaction of the so-called oxidant redox species leads to the oxidation of the metallic lithium in ionic form.

According to another example, in the case of a lithium-ion accumulator, the reduction reaction of the so-called oxidant redox species leads to the deinsertion of the lithium ion from the active material of the negative electrode.

The free ions extracted from the anode, migrate through the ion-conductive electrolyte and are immobilised in the cathode where they form a thermodynamically stable lithium oxide. By thermodynamically stable, it should be understood that the oxide does not react violently with water and/or air.

Advantageously, the solution comprises a second so-called reductant redox species able to be oxidised on the positive electrode, the so-called oxidant redox species and the so-called reductant redox species forming a pair of redox species.

By redox pair, also called redox mediator or electrochemical shuttle, it should be understood an oxidant/reductant (Ox/Red) pair in solution whose oxidant can be reduced on the anode (negative electrode) and the reductant can be oxidised on the cathode (positive electrode). The oxidation of the reductant and the reduction of the oxidant allow forming new oxidant/reductant species and/or regenerating the species initially present in solution. The method is economical since the redox pair in solution ensures at the same time and simultaneously the redox reactions at the electrodes/terminals of the electrochemical generator, so that the consumption of reagent is zero; the solution can be used to secure several electrochemical generators successively and/or in a mixture.

The redox species allow(s) discharging the electrochemical generator significantly and possibly completely. In addition, in case of break-up of the packaging, they will react with the inner components, so as to reduce the potential difference between the electrodes (anode and cathode). This internal discharge also participates in securing the electrochemical generator by reducing the chemical energy of the electrodes (and therefore the potential difference) and by reducing the internal short-circuit effect. The electrochemical generator is safeguarded even in the event of a structural deterioration.

The absence of water allows avoiding the generation of hydrogen, the main obstacle to the use of aqueous extinguishing agents which could generate explosive atmospheres.

Advantageously, the pair of redox species is a metallic pair, preferably selected from among Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, a pair of organic molecules, a pair of metallocenes such as Fc/Fc⁺, or a pair of halogenated molecules like for example Cl₂/Cl⁻ or Cl⁻/Cl₃⁻.

Advantageously, the ionic liquid solution comprises an additional ionic liquid.

Advantageously, the ionic liquid solution forms a deep eutectic solvent.

Advantageously, the electrically-conductive powder comprises particles made of a carbonated material.

According to a first advantageous variant, the discharge of the electrochemical generator is carried out under air.

According to a second advantageous variant, the discharge of the electrochemical generator is carried out under an inert atmosphere enabling the control of the oxygen content. Thus, the whole is secured (with regards to the triangle of fire).

Advantageously, the discharge of the electrochemical generator is carried out at a temperature ranging from 5° C. to 80° C., and preferably from 20° C. to 60° C.

Advantageously, the method comprises, prior to the step of discharging the electrochemical generator, a dismantling step and/or a sorting step.

Advantageously, the method comprises, subsequently to the step of discharging the electrochemical generator, a storage step and/or a pyrometallurgical and/or hydrometallurgical step.

Advantageously, the method is carried out during the transport of the electrochemical generator, for example, towards a recycling site and/or towards a dismantling site. Thus, the electrochemical generators can be discharged during transport thereof from one site to another (time saving) while avoiding the flammability risks (safety during transport).

It is obvious that several electrochemical generators of the same kind or of different kinds could be discharged simultaneously in the same ionic liquid solution.

It is possible to adapt the composition of the ionic liquid solution according to the nature and/or amount of the electrochemical generator(s) as well as the duration of transport. Thus, it is possible to carry out a discharge that is either quick (typically a discharge shorter than 10 h and preferably shorter than 3 h) or slow.

The discharge method according to the invention has many advantages:
Implement a discharge step in one single step in an ionic liquid avoiding a violent reaction with water and/or air, which avoids not only the problems relates to management of hydrogen, oxygen and heat, and therefore to management of an explosive atmosphere (safety, treatments of effluents, economical over-cost), but also avoids using large volumes of water and therefore treating aqueous effluents; the use of an ionic liquid also avoids corrosion of the electrochemical generator,
The discharge causes no damage of the objects and does not consume reagents.

The discharge being controlled by the nature of the components of the ionic liquid solution, the discharge may be extremely quick (for example shorter than 1 h).

Using no heat treatment, which avoids problems related to the emission of gases (for example greenhouse gases or for any other harmful and hazardous gas for humans and the environment), in particular with regards to treatment thereof, and reduces the financial and energy costs of the method.

The treatment is compatible with recycling of the different components of the electrochemical generator (in particular the electrolyte is not degraded).

Safeguarding the electrochemical generator is simple to implement.

Other features and advantages of the invention will arise from the following complementary description.

It goes without saying that this additional description is provided solely for the purpose of illustrating the object of the invention and must not be interpreted as constituting a limitation thereto in any way.

### BRIEF DESCRIPTION OF THE DRAWINGS

The present invention will be better understood upon reading the description of embodiments given for merely indicative and non-limiting purposes with reference to the unique appended FIGURE.

FIG. 1 schematically represents, in sectional view, a lithium-ion accumulator, according to a particular embodiment of the invention.

The different portions represented in the figures are not necessarily plotted according to a uniform scale, to make the figures more readable.

### DETAILED DISCLOSURE OF PARTICULAR EMBODIMENTS

Next, even though the description refers to a Li-ion accumulator, the invention could be transposed to any electrochemical generator, for example to a battery comprising several accumulators (also called accumulator batteries), connected in series or in parallel, according to the rated operating voltage and/or the amount of energy to supply, to a battery module, or to an electrical cell.

The safety method concerns all accumulator or cell type electrochemical systems treated separately or as a mixture.

These different electrochemical devices can be of the metal-ion type, for example lithium-ion or sodium-ion, or else of the Li-metal type, . . .

It may also consist of a primary system such as Li/MnO₂, or else a flow battery (“Redox Flow Battery”).

Advantageously, an electrochemical generator having a potential greater than 1.5V will be selected.

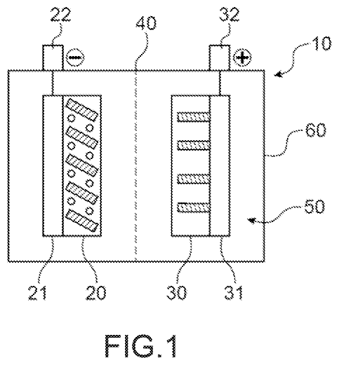

First, reference is made to FIG. 1 which represents a lithium-ion (or Li-ion) accumulator 10. A single electrochemical cell is represented but the generator may comprise several electrochemical cells, each cell comprising a first electrode 20, herein the anode, and a second electrode 30, herein the cathode, a separator 40 and an electrolyte 50. According to another embodiment, the first electrode 20 and the second electrode 30 could be reversed.

Preferably, the anode (negative electrode) 20 is carbon-based, for example, made of graphite which can be mixed with a PVDF type binder and deposited over a copper sheet. It may also consist of a lithium mixed oxide like lithium titanate Li₄Ti₅O₁₂ (LTO) for a Li-ion accumulator or a sodium mixed oxide like sodium titanate for a Na-Ion accumulator. It could also consist of a lithium alloy or a sodium alloy depending on the selected technology.

The cathode (positive electrode) 30 is a lithium ion insert material for a Li-ion accumulator. It may consist of a lamellar oxide such as LiMO₂, a phosphate LiMPO₄ with an olivine structure or a spinel compound LiMn₂O₄, With M representing a transition metal. For example, a positive electrode made of LiCoO₂, LiMnO₂, LiNiO₂, Li₃NiMnCoO₆, LiNiₓCo₁₋ₓ O₂ (with 0<x<1) or LiFePO₄ will be selected.

The cathode (positive electrode) 30 is a sodium ion insert material for a Na-ion accumulator. It may consist of a sodium oxide type material comprising at least one transition metal element, a sodium phosphate or sulphate type material comprising at least one transition metal element, a sodium fluoride type material, or a sulphide type material comprising at least one transition metal element.

The insert material can be mixed with a binder of the polyvinylidene fluoride type and deposited over an aluminium sheet.

The electrolyte 50 includes lithium salts (LiPF₆, LiBF₄, LiClO₄ for example) or sodium salts (N₃Na for example), depending on the selected accumulator technology, dissolved in a mixture of non-aqueous solvents. For example, the mixture of solvents is a binary or ternary mixture. For example, the solvents are selected from among solvents based on cyclic carbonates (ethylene carbonate, propylene carbonate, butylene carbonate), linear or branched (dimethyl carbonate, di-ethyl carbonate, ethyl methyl carbonate, dimethoxyethane) in various proportions.

Alternatively, it could also consist of a polymer electrolyte comprising a polymer matrix, made of an organic and/or inorganic material, a liquid mixture comprising one or more metal salt(s), and possibly a mechanical reinforcement material. The polymer matrix may comprise one or more polymer material(s), for example selected from among a polyvinylidene fluoride (PVDF), a polyacrylonitrile (PAN), a polyvinylidene fluoride hexafluoropropylene (PVDF-HFP), or a poly(ionic liquid) of the poly(N-vinylimidazolium)bis(trifluoromethanesulfonylamide)), N,N-diethyl-N-(2-methoxyethyl)-N-methylammonium bis(trifluoromethylsulfonyl)imide (DEMM-TFSI) type.

The cell may be wound on itself around a winding axis or have a stacked architecture.

A case 60 (“casing”), for example a pocket made of polymer, or a metal packaging, for example made of steel, allows ensuring tightness of the accumulator.

Each electrode 20, 30 is connected to a current collector 21, 31 passing through the case 60 and forming, outside the case 60, the terminals 22, 32 respectively (also called output terminals or electrical poles or terminals). The function of the collectors 21, 31 is dual: to ensure mechanical support for the active material and electrical conduction up to the terminals of the cell. The terminals, also called electrical poles or terminals, form the output terminals and are intended to be connected to an “energy receiver”.

According to some configurations, one of the terminals 22, 32 (for example that one connected to the negative electrode) can be connected to the ground of the electrochemical generator. It is then said that the ground is the negative potential of the electrochemical generator and that the positive terminal is the positive potential of the electrochemical generator. Hence, the positive potential is defined as the positive pole/terminal as well as all metallic parts connected by electrical continuity from this pole.

An intermediate electronic device may possibly be disposed between the terminal that is connected to ground and the latter.

The method for discharging the electrochemical generator 10 comprises a step during which an electrochemical generator 10 and an ionic liquid solution comprising an ionic liquid and an electrically-conductive powder are brought into contact, preferably by immersion, so as to discharge the electrochemical generator.

This step allows discharging the electrochemical generator 10 and thus safeguarding it.

By discharge, it should be understood that the method allows significantly reducing the electric charge of the electrochemical generator 10, by at least 50% and preferably by at least 80%, and possibly completely discharging the electrochemical generator (100%). The discharge rate depends on the initial state-of-charge.

The ionic liquid solution 100, also called ionic liquid solution, not only prevents contact between the waste (cells or accumulators)/water/air thanks to the presence of the ionic liquid but also ensures the discharge of the waste via the powder. Hence, the set is secured against the fire triangle (oxidant, fuel, energy), avoiding/or minimising the presence of water at the origin of the formation of an explosive atmosphere (H₂, O₂ gas with heat).

Preferably, the electrochemical generator 10 is completely discharged. The discharge time will be estimated according to the nature of the cells and accumulators and the charge rate.

The ionic liquid solution 100 comprises at least one ionic liquid LI₁, called solvent ionic liquid, and a redox active species.

By ionic liquid, it should be understood the combination comprising at least one cation and one anion which generates a liquid with a melting point lower than or close to 100° C. These consist of molten salts.

By “solvent ionic liquid”, it should be understood an ionic liquid that is thermally and electrochemically stable, minimising an effect of degradation of the medium during the discharge phenomenon.

The ionic liquid solution 100 may also comprise an additional ionic liquid denoted LI₂ or several (two, three, . . . ) additional ionic liquids, i.e. it comprises a mixture of several ionic liquids.

By “additional ionic liquid”, it should be understood an ionic liquid that promotes one or more propert(y/ies) with regards to the securing and discharge step. In particular, it may consist of one or more of the following properties: extinction, flame retardant intended to prevent a thermal runaway, redox shuttle, salt stabiliser, viscosity, solubility, hydrophobicity, conductivity.

Advantageously, the ionic liquid, and possibly, the additional ionic liquids are liquid at room temperature (from 20 to 25° C.).

For the solvent ionic liquid and for the additional ionic liquid(s), the cation is preferably selected from among the family: imidazolium, pyrrolidinium, ammonium, piperidinium and phosphonium.

Advantageously, a cation with a wide cationic window will be selected, wide enough to consider a cathodic reaction avoiding or minimising the degradation of the ionic liquid.

Advantageously, LI₁ and LI₂ will have the same cation to increase the solubility of LI₂ in LI₁.

Advantageously, anions allowing simultaneously obtaining a wide electrochemical window, a moderate viscosity, a low melting temperature (liquid at room temperature) and a good solubility with the ionic liquid and the other species of the solution will be used, while that not leading to the hydrolysis (degradation) of the ionic liquid.

The TFSI anion is an example that meets the aforementioned criteria for numerous associations with, for example, for LI₁: [BMIM][TFSI], or the use of a [P66614][TFSI] type ionic liquid, the ionic liquid 1-ethyl-2,3-trimethyleneimidazolium bis(trifluoromethanesulfonyl)imide ([ETMIm][TFSI]), the ionic liquid N,N-diethyl-N-methyl-N-2-methoxyethyl ammonium bis(trifluoromethylsulfonyl)amide [DEME][TFSA], the ionic liquid N-methyl-N-butylpyrrolidinium bis(trifluoromethylsulfonyl)imide ([PYR14][TFSI]), the ionic liquid N-methyl-N-propylpiperidinium bis(trifluoromethanesulfonyl)imide (PP13-TFSI).

The anion may also be of the bis(fluorosulfonyl)imide (FSA or FSI) type, like the ionic liquid N-methyl-N-propylpyrrolidinium FSI (P13-FSI), N-methyl-N-propylpiperidinium FSI (PP13-FSI), 1-ethyl-3-methylimidazolium FSI (EMI-FSI), etc. . . .

Advantageously, the anion of the solvent ionic liquid LI₁ and/or the anion of the additional ionic liquid LI₂ may be fitted with a complexing anion to form a complex with the electrochemical shuttle.

Other associations may be considered, with ionic liquids (LI₁) whose cation will be associated with an anion which will be either organic or inorganic, preferably having a wide anodic window.

In the numerous possible systems, preference will be given to a non-toxic low-cost medium with low environmental impact (biodegradability). Toxicity and biodegradability are related to those of their components. Thus, one would look for media that have a high biodegradability and that are considered as non-toxic and even able to be used as a food additive.

Advantageously, the ionic liquid solution forms a deep eutectic solvent (or DES standing for “deep eutectic solvents”). It consists of a liquid mixture at room temperature obtained by forming a eutectic mixture of 2 salts, of general formula [Cat]⁺·[X]⁻·z[Y]
with:
   -[Cat]⁺ is the cation of the solvent ionic liquid (for example ammonium),
[X]⁻ the halide anion (for example Cl⁻),
[Y] a Lewis or Bronsted acid which can be complexed by the anion X⁻ of the solvent ionic liquid, and
z the number of molecules Y.

Eutectics can be divided into three categories depending on the nature of Y.

The first category corresponds to a type I eutectic:
Y=MClₓ for example with M=Fe, Zn, Sn, Fe, Al, Ga

The first category corresponds to a type II eutectic:
Y=MClₓ·yH₂O for example with M=Cr, Co, Cu, Ni, Fe

The first category corresponds to a type III eutectic:
Y=RZ for example with Z=CONH₂, COOH, OH.

For example, DES is choline chloride associated with an H-bond donor with a very low toxicity, like glycerol or urea, which guarantees a non-toxic and very low-cost DES.

According to another embodiment, choline chloride may be replaced by betaine. Even though these systems have a limited window of electrochemical stability, they allow guaranteeing flooding and deactivation of an accumulator possibly open.

Advantageously, a compound “Y” which can serve as an electrochemical shuttle, which can be oxidised and/or reduced, will be selected. For example, Y is a metal salt, which can be dissolved in the ionic liquid solution so as to form metal ions. For example, Y contains iron.

For illustration, it is possible to form an eutectic between an ionic liquid with a chloride anion and metal salts FeCl₂ and FeCl₃ for different proportions and with different cations.

It is also possible to carry out this type of reactions with type II eutectics which integrate in the metal salts water molecules when the water proportion is low, this generates to danger. Typically, by low, it should be understood less than 10% by weight of the solution, for example from 5 to 10% by weight of the solution.

It is also possible to use type III eutectics which associate the ionic liquid and hydrogen bond donor species (Y), with a [LI₁]/[Y] type mixture where LI₁ may be a quaternary ammonium and Y a complexing molecule (hydrogen bond donor) such as urea, ethylene glycol, thiourea, etc. . . .

It is also possible to make a mixture which will advantageously modify the properties of the solution for the discharge of the medium. In particular, it is possible to combine a [BMIM][NTF₂] type solvent ionic liquid which is very stable and liquid at room temperature, but which barely solubilises the electrochemical shuttle (or redox mediator), like an iron chloride.

For example, it is possible to combine an additional ionic liquid LI₂ of the [BMIM][Cl] type which will promote the solubilisation of a metal salt in the form of a chloride by complexation with the LI₂ anion. This allows simultaneously having good transport properties, good solubility of the redox mediator and therefore promoting the discharge phenomenon.

The ionic liquid solution comprises an electrically-conductive powder.

The powder is formed by electrically-conductive particles.

For example, the electrically-conductive particles are metallic, made of a ceramic, of a polymer or it may consist of a combination of the aforementioned materials in various proportions to obtain a suitable resistance for the selected discharge time, but also to promote heat dissipation.

Preferably, the particles are made of a carbonated material.

By carbonated material, it should be understood a solid compound based on carbon atoms which is characterised in particular by its good electrical and heat conductivity, its temperature resistance and its chemical inertia (except for oxidation). A non-limiting example corresponds to carbon/graphite in Li-on batteries.

The carbon/graphite particles may be used alone. Advantageously, they come from a battery.

Alternatively, a mixture of carbon/graphite particles and of conductive metal particles like copper, aluminium, steel, etc., will be selected.

For example, the size of the particles will be from 100 μm to 20 mm, and preferably from 500 μm to 2 mm.

Preferably, the powder is chemically stable in solution to avoid dissolution thereof and/or the loss of these properties over time.

The powder has an electrical resistivity suited to enable control of the discharge current and mastering the dissipated thermal power. For example, the electrical resistivity is from 10⁻⁹ to 100 Ohm·m. For example, an electrical resistivity of 40×10⁻⁶ Ohm·m will be selected.

Mastering the discharge also depends on the concentration of the powder in solution and on the object to be discharged. In particular, to obtain a resistance suited to the desired discharge time, it is possible to take account of the distance between the positive and negative poles, the nature of the object (architecture of the module, geometry of the cell and rated capacity), but also the energised surface (bulbar, terminals).

Preferably, we will select parameters (amount of powder, nature of the powder, grain-size distribution, etc. . . . ) allowing for a discharge time shorter than 24 h, preferably shorter than 10 h and more advantageously shorter than 2 h. For example, the resistance between the positive terminal and the negative terminal of the electrochemical generator once immersed in the ionic liquid is comprised between 1 mΩ and 100Ω, more advantageously between 10 mΩ and 10Ω (bearing in mind that resistance corresponds to R=ρ*I/S, with ρ the resistivity, I the length between the two poles and S the cross-sectional area). The resistance will be different from zero to avoid a brutal discharge, equivalent to a short-circuit and a risk of explosion and degradation of the accumulator.

The ionic liquid solution, a powder/solution combination, ensures an electrical conduction suited for the resistive discharge and for a sufficient heat dissipation. Depending on the power of the electrochemical generator, it is possible to modify, on the one hand, the powder/solution ratio of the solution and, on the other hand, the ratio between the solution volume and the mass of the electrochemical generator to be treated.

Preferably, the powder/solution ratio will be comprised between 1% and 70%, preferably between 5% and 50% by weight.

For example, the mass ratio between the electrochemical generator and the solution volume (kg/L), will be between 1 and 100, preferably between 2 and 20.

Furthermore, the ionic liquid solution may comprise a redox species (also called redox mediator). It consists of an ion or a species in solution capable of being reduced on the negative electrode 20, or on the terminal 22 connected to the negative electrode 20. This allows extracting the lithium of the negative electrode to make the accumulator non-reactive to air.

The use of an electrochemical shuttle allows making the device operate in a closed loop. It may consist of an electrochemical pair or association thereof. Preferably, it consists of a redox pair serving as an electrochemical shuttle (or redox mediator) to reduce the degradation of the medium, by ensuring the redox reactions.

By redox pair, it should be understood an oxidant and a reductant in solution capable of being, respectively, reduced and oxidised on the electrodes/terminals of the batteries. The oxidant and the reductant may be introduced in an equimolar or non-equimolar proportion.

The redox pair may be a metal electrochemical pair or one of their associations: Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

In the case where the electrochemical generator is opened, one of the redox species may originate from the generator itself. In particular, it consists of cobalt, nickel and/or manganese.

The redox species and the redox pair may also be selected from among organic molecules, and in particular from among: 2,4,6-tri-t-butylphenoxyl, nitronyl nitroxide/2,2,6,6-tetramethyl-1-piperidinyloxy (TEMPO), tetracyanoethylene, tetramethylphenylenedi-amine, dihydrophenazine, aromatic molecules for example having a methoxy group, an N,N-dimethylamino group such as methoxybenzene anisole, dimethoxybenzene, or else an N,N-dimethylaniline group such as N,N-dimethylaminobenzene. Mention may also be made of 10-methyl-phenothiazine (MPT), 2,5-di-tert-butyl-1,4-dimethoxybenzene (DDB) and 2-(pentafluorophenyl)-tetrafluoro-1,3,2-benzodioxaborole (PFPTFBDB).

It may also consist of the family of metallocenes (Fc/Fc+, Fe(bpy)₃(ClO₄)₂ and Fe(phen)₃(ClO₄)₂ and derivatives thereof) or the family of halogenated molecules (Cl₂/Cl⁻, Cl⁻/Cl₃—, Br₂/Br⁻, I₂/I⁻, I⁻/I₃⁻).

In particular, a bromide or a chloride will be selected. Preferably, it consists of a chloride, which can easily complex metals. For example, iron, complexed by the chloride anion, forms FeCl₄⁻ which can decrease the reactivity of the negative electrode.

It may also consist of tetramethylphenylenediamine.

It will also be possible to associate several redox pairs, wherein metals of the metal ions of which are identical or different.

For example, Fe²⁺/Fe³⁺ and/or Cu⁺/Cu²⁺ will be selected. These are soluble in their two oxidation states, they are not toxic, they do not degrade the ionic liquid and they have adequate redox potentials to extract the lithium in the case where the cell is opened. It will also be possible to select the V²⁺/V³⁺ and V⁴⁺/V⁵⁺ combination.

The ionic liquid solution may include one or more active species like a fire suppression agent or a flame retardant intended to prevent a thermal runaway, in particular in the event where an accumulator is opened. It may consist of an alkyl phosphate, possibly fluorinated (fluorinated alkyl phosphate), like trimethyl phosphate, triethyl phosphate, or tris (2,2,2-trifluoroethyl) phosphate). The active species concentration may be from 80% by weight to 5%, preferably from 30% to 10% by weight.

Optionally, the ionic liquid solution may comprise a desiccant agent, and/or a matter transport promoting agent, and/or a protective agent which is a stabiliser/reducer of corrosive and toxic species like PF₅, HF, POF₃, etc.

For example, the matter transport promoting agent is a fraction of a co-solvent which may be added to reduce viscosity.

Preferably, an organic solvent will be selected in order to act effectively without generating any discharge or flammability risks. It may consist of vinylene carbonate (VC), gamma-butyrolactone (γ-BL), propylene carbonate (PC), poly(ethylene glycol), dimethyl ether. Advantageously, the concentration of the agent promoting the transport of matter ranges from 1% to 40% and more advantageously from 10% to 40% by weight.

The protective agent able to reduce and/or stabilise corrosive an/or toxic elements is, for example, a compound such as butylamine, a carbodiimide (such as N,N-dicyclohexylcarbodiimide), N,N-diethylamino trimethylsilane, tris(2,2,2-trifluoroethyl) phosphite (TTFP), an amine-based compound like 1-methyl-2-pyrrolidinone, a fluorinated carbamate or hexamethyl-phosphoramide. It may also be a compound from the cyclophosphazene family like hexamethoxycyclotriphosphazene.

Advantageously, a composite material, which is a phase-change material, may be added to the ionic liquid solution. For example, this composite material is the combination of a paraffin with a heat-transfer element which, without limitation, may consist of carbon, aluminium, copper or any other material that promotes the heat conductivity of the mixture. This mixture has favourable thermo-physical properties (mass heat capacity, latent heat and heat conductivity) for capturing heat and rendering it.

Advantageously, the thermal energy absorbed by the solution during the resistive discharge process may be recovered with a heat exchanger. Thus, it would be possible to operate a continuous energy discharge and recovery process by continuous circulation of the ionic liquid solution between the discharge reactor and the heat exchanger.

Preferably, the temperature of the ionic liquid solution in which the electrochemical generator is immersed does not exceed 60° C., to avoid internal degradation reactions of the electrolyte of the electrochemical generator and/or avoid a runaway process leading to a degradation and/or to an explosion.

The discharge step may be implemented at temperatures ranging from 20° C. to 60° C., preferably from 20° C. to 40° C. and even more preferably at room temperature (20-25° C.).

The method may be carried out under an inert atmosphere, for example under argon, carbon dioxide, nitrogen or a mixture thereof.

The ionic liquid solution may be cooled to remove calories during the discharge process.

The ionic liquid solution may be stirred to improve the reactant supply and/or to improve cooling.

The discharge method allows safely discharging the electrochemical generator for recycling thereof (through a pyrometallurgical process and/or through a hydrometallurgical process) or for storage thereof. For example, it may consist of a temporary storage while waiting to transfer it, for example to a recycling plant to recover these different components.

Advantageously, the discharge method may be carried out during the transport of the electrochemical generator, which allows for a considerable time saving and makes the transport of the electrochemical generator safe.

For illustration, a recycling method may comprise the following steps: sorting, dismantlement, discharge according to the previously-described method, recycling by conventional processes (pyrometallurgical, hydrometallurgical, etc.).

Afterwards, the recoverable fractions of the electrochemical generator can be recovered and reused.

What is claimed is:

1.-11. (canceled)

12. A method for discharging an electrochemical generator comprising a negative electrode containing lithium or sodium and a positive electrode, the method comprising a step of discharging the electrochemical generator during which the electrochemical generator is brought into contact with an ionic liquid solution comprising a solvent ionic liquid and an electrically-conductive powder so as to discharge it.

13. The method according to claim 12, wherein the positive electrode contains lithium or sodium.

14. The method according to claim 12, wherein the ionic liquid solution further comprises a so-called oxidant redox species able to be reduced on the negative electrode.

15. The method according to claim 12, wherein the ionic liquid solution comprises a so-called reducing second redox species able to be oxidised on the positive electrode, the so-called oxidant redox species and the so-called reductant redox species forming a redox species pair.

16. The method according to claim 12, wherein the pair of redox species is a metallic pair, a pair of organic molecules, a pair of metallocenes, or a pair of halogenated molecules.

17. The method according to claim 16, wherein the metallic pair is selected from among Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

18. The method according to claim 16, wherein the pair of redox species is a pair of metallocenes being Fc/Fc⁺.

19. The method according to claim 16, wherein the pair of redox species is a pair of halogenated molecules selected from Cl₂/Cl⁻ or Cl⁻/Cl₃⁻.

20. The method according to claim 12, wherein the ionic liquid solution comprises an additional ionic liquid.

21. The method according to claim 12, wherein the ionic liquid solution forms a deep eutectic solvent.

22. The method according to claim 12, wherein the discharge of the electrochemical generator is carried out under air or under an inert atmosphere.

23. The method according to claim 12, wherein the method comprises, prior to the step of discharging the electrochemical generator, a dismantlement step or a sorting step.

24. The method according to claim 12, wherein the method comprises, subsequently to the step of discharging the electrochemical generator, a storage step or a pyrometallurgical or hydrometallurgical step.

25. The method according to claim 12, wherein the electrically-conductive powder comprises particles made of a carbonated material.

26. The method according to claim 12, wherein the method is carried out during the transport of the electrochemical generator.

27. The method according to claim 26, wherein the method is carried out during the transport of the electrochemical generator towards a recycling or dismantling site.
